(19) United States
(12) Patent Application Publication
(10) Pub. No.: US 2026/0251677 A1
(43) Pub. Date: Aug. 27, 2026

(54) SINGLE-CRYSTAL DIAMOND PROBE CANTILEVER FOR HIGH-SPEED ATOMIC FORCE MICROSCOPE AND FABRICATION THEREOF

(71) Applicant: INSTITUTE OF PHYSICS, CHINESE ACADEMY OF SCIENCES, Beijing (CN)

(72) Inventors: Fang JIAO, Beijing (CN); Ou ZHANG, Beijing (CN); Sichen MI, Beijing (CN)

(21) Appl. No.: 19/312,771

(22) Filed: Aug. 28, 2025

(30) Foreign Application Priority Data
Feb. 27, 2025 (CN) 202510227451.7

(51) Int. Cl. G01Q 60/38

(52) U.S. Cl. CPC G01Q 60/38

(57) ABSTRACT

Provided is a single-crystal diamond probe cantilever for a high-speed atomic force microscope and a fabrication method thereof. The fabrication method includes: obtaining a single-crystal diamond film with a specified thickness; aligning a laser beam with a side edge of the film, and cutting the film along a bottom edge of one end of the film at a set angle between the laser beam and a surface of the film, to obtain the single-crystal diamond film having an oblique angle of the set angle at the one end; cutting the one end of the single-crystal diamond film having the oblique angle with a laser beam, from the side of a flat surface of the single-crystal diamond film, to obtain a pre-pattern of a cantilever; and carrying out fine nanofabrication on the cantilever using a focused ion beam, to obtain a single-crystal diamond probe cantilever of a target size.

### CROSS-REFERENCE TO RELATED APPLICATIONS

The present application claims priority to Chinese patent application No. 202510227451.7 entitled “Single-crystal Diamond Probe Cantilever for High-Speed Atomic Force Microscope and Fabrication thereof”, filed on Feb. 27, 2025, the entire contents of which are incorporated herein by reference.

### TECHNICAL FIELD

The present disclosure relates to the technical fields of atomic force microscopy detection and nanoscale measurement, and specifically relates to a single-crystal diamond probe cantilever for a high-speed atomic force microscope and a fabrication method thereof.

### BACKGROUND

With the advancement of atomic force microscopy technologies, high-speed atomic force microscopes (High-Speed AFMs) have become important research tools in materials science, biology, semiconductors, and other fields due to its ability to achieve fast and high-resolution imaging at the nanoscale. However, the existing high-speed probes still have many limitations in material performance and dynamic characteristics. Despite having shown certain performance advantages in high-speed atomic force microscopes, ultrathin quartz-like cantilever probes represented by Nanoworld still have significant limitations in material characteristics. Specifically, the elastic modulus and density of quartz-like materials limit their performance during high-frequency scanning, resulting in a lower inherent frequency of a quartz-like cantilever and difficulty in meeting the demand for higher scanning speed.

Single-crystal diamonds have become an ideal material to break through the limitations of the prior art due to extremely high hardness (Mohs hardness 10), elastic modulus (about 1050 GPa), low density (about 3.5 g/cm³), excellent thermal conductivity (about 2320 W/(m·K)), chemical inertness, and favorable biocompatibility thereof. The single-crystal diamonds have high hardness and wear resistance which significantly extend a service life of a probe, excellent elastic modulus and rigidity which improve an imaging resolution, and low density and high inherent frequency which support a higher scanning speed. However, significant challenges are faced in fabrication of ultrathin high-speed single-crystal diamond probe cantilevers. Unlike silicon-based materials, the fabrication of integrated cantilever structures based on single-crystal diamond films involves complex micro/nano fabrication processes. A Focused Ion Beam (FIB) technique is a technique that may achieve manufacturing of nanoscale ultrathin single-crystal diamond structures. However, due to inherent limitations of devices, FIB has low fabrication efficiency for large-area and thick structures, and is prone to cause lattice damage. It is difficult to achieve simple, efficient, low-cost, and high-quality manufacturing of integrated single-crystal diamond probe cantilevers by the prior art.

Therefore, a new technical solution is required to achieve simple, efficient, reproducible, low-cost, and high-quality manufacturing of integrated single-crystal diamond probe cantilevers, and solve huge technical challenges faced in manufacturing the ultra-thin integrated single-crystal diamond probe cantilevers.

### SUMMARY

Given the technical challenges faced in the fabrication of ultrathin high-speed single-crystal diamond probe cantilevers in related technologies, to overcome or at least partially solve the aforementioned problems, the present disclosure provides a single-crystal diamond probe cantilever for a high-speed atomic force microscope and a fabrication method thereof.

An objective of the present disclosure is to achieve manufacturing of an ultrathin integrated single-crystal diamond cantilever.

A further objective of the present disclosure is to improve the fabrication quality of a single-crystal diamond cantilever, and achieve simple, efficient, reproducible, and low-cost manufacturing of the single-crystal diamond cantilever. The single-crystal diamond cantilever fabricated by the provided method has obvious advantages of adjustable thickness, no need for additional polishing or cleaning treatment after fabrication of the diamond cantilever, and an integrated structure compatible with various commercial scanning atomic force microscopes.

Specifically, according to one aspect of the present disclosure, provided is a method for fabricating a single-crystal diamond probe cantilever for a high-speed atomic force microscope, including:
obtaining a single-crystal diamond film with a specified thickness;
aligning a laser beam with a side edge of the film, and cutting the film along a bottom edge of one end of the film at a set angle between the laser beam and a surface of the film, to obtain the single-crystal diamond film having an oblique angle of the set angle at the one end;
cutting the one end of the single-crystal diamond film having the oblique angle with a laser beam, from the side of a flat surface of the single-crystal diamond film, to obtain a pre-pattern of a cantilever; and
carrying out fine nanofabrication on the cantilever using a focused ion beam, to obtain a single-crystal diamond probe cantilever of a target size.

Optionally, the set angle is in a range of 5-20°.

Optionally, the specified thickness is in a range of 30-70 μm; and a target thickness of the cantilever is in a range of 50 -250 nm.

Optionally, a step of obtaining a single-crystal diamond film with a specified thickness includes:
carrying out double-side fine mechanical polishing on a bulk single-crystal diamond; and
cutting the bulk single-crystal diamond by a laser beam, and mechanically polishing a cut surface of the bulk single-crystal diamond, to obtain the single-crystal diamond film with the specified thickness.

Optionally, the step of obtaining a single-crystal diamond film with a specified thickness further includes:
boiling the single-crystal diamond film with an acid solution, to remove impurities from surfaces of the single-crystal diamond film,
wherein the acid solution is a mixture of concentrated sulfuric acid and concentrated nitric acid, with a volume ratio of concentrated sulfuric acid to concentrated nitric acid being 3:1; and
a boiling temperature is maintained at 180-220° C.

Optionally, a step of carrying out fine nanofabrication on the cantilever using a focused ion beam, to obtain a single-crystal diamond probe cantilever of a target size includes:
fixing the single-crystal diamond film with the pre-pattern of the cantilever to an edge of a silicon wafer in a manner that the cantilever is suspended; and
carrying out multiple fine nanofabrication on the cantilever using ion beams with sequentially degreased energy.

Optionally, a step of carrying out multiple fine nanofabrication on the cantilever using ion beams with sequentially degreased energy includes:
carrying out rough machining on the cantilever using an ion beam of first energy;
carrying out fine machining on the cantilever using an ion beam of second energy; and
carrying out amorphous-portion-removing machining on the cantilever using an ion beam of third energy to remove an amorphous portion from a surface of the cantilever, wherein the second energy is lower than the first energy but higher than the third energy.

Optionally, the first energy is in a range of 20-30 kV;
the second energy is in a range of 10-20 kV; and
the third energy is in a range of 3-5 kV.

Optionally, after carrying out fine nanofabrication on the cantilever using a focused ion beam, the method further includes:
annealing the single-crystal diamond film in a vacuum environment.

Optionally, a step of annealing the single-crystal diamond film in a vacuum environment includes:
fixing the single-crystal diamond film in a grooved high-temperature resistant mold;
sealing the mold in high vacuum by a vacuum glass tube sealing technique; and
annealing the single-crystal diamond film at an annealing temperature of 900° C. or higher.

According to another aspect of the present disclosure, provided further is a single-crystal diamond probe cantilever for a high-speed atomic force microscope, which is fabricated by the aforementioned method.

According to the method for fabricating a single-crystal diamond probe cantilever for a high-speed atomic force microscope provided by the present disclosure, firstly, a single-crystal diamond film with a specified thickness is cut at an angle using a laser beam to obtain a single-crystal diamond film having an oblique angle at one end; then, a pre-pattern of a cantilever is formed by cutting from the end where the oblique angle is located with a laser beam; and then fine nanofabrication is carried out on the cantilever using a focused ion beam technique, to finally obtain an integrated ultrathin single-crystal diamond cantilever of a required size.

Further, the single-crystal diamond film with the specified thickness can be obtained by carrying out laser cutting and polishing on a polished bulk single-crystal diamond, which expands the sources of single-crystal diamond films for fabrication of single-crystal diamond cantilevers.

Further, by cutting out the oblique angle and cutting out the pre-pattern of the cantilever on the polished bulk single-crystal diamond with a laser beam, the single-crystal diamond film having a specified oblique angle and the pre-pattern of the cantilever is obtained, which greatly reduces an area and depth in subsequent focused ion beam nanofabrication, greatly improves fabrication efficiency, and reduces fabrication costs.

Further, in the process of nanofabrication of the cantilever using focused ion beams, multiple fine nanofabrication is carried out on the cantilever using ion beams with sequentially decreased energy, which minimizes the lattice damage caused by the focused ion beams and thus improves the fabrication quality of the single-crystal diamond cantilever.

The above description is only an overview of the technical solution of the present disclosure. To have a clearer understanding of the technical means of the present disclosure, enable implementation according to the content of the specification, and make the above and other objectives, features, and advantages of the present disclosure more obvious and understandable, specific implementations of the present disclosure are illustrated below.

The above and other objectives, advantages and features of the present disclosure will be more apparent to those skilled in the art from the following detailed description of specific embodiments of the present disclosure with reference to the drawings.

### BRIEF DESCRIPTION OF THE DRAWINGS

By reading detailed descriptions of preferred implementations below, various other advantages and benefits will become apparent to those of ordinary skill in the art. The accompanying drawings are only used for illustrating the preferred implementations, but are not considered a limitation on the present disclosure. Furthermore, the same components are denoted by the same reference numerals throughout the drawings. In the accompanying drawings:

FIG. 1 shows a schematic flowchart of a method for fabricating a single-crystal diamond probe cantilever for a high-speed atomic force microscope according to an embodiment of the present disclosure;

FIG. 2 shows a schematic flowchart of a method for fabricating a single-crystal diamond probe cantilever for a high-speed atomic force microscope according to another embodiment of the present disclosure;

FIG. 3a to FIG. 3e show schematic diagrams of a fabrication process of a high-speed single-crystal diamond probe cantilever in an embodiment of the present disclosure;

FIG. 4a and FIG. 4b show a top view and a side view under an electron microscope of a single-crystal diamond film having a cutting angle of 10°, which is obtained in an embodiment of the present disclosure;

FIG. 5a and FIG. 5b show a top view and a side view under an electron microscope of a cantilever structure fabricated in an embodiment of the present disclosure prior to focused ion beam machining; and

FIG. 6 shows a side view under an electron microscope of a cantilever structure fabricated in an embodiment of the present disclosure after focused ion beam machining.

### DETAILED DESCRIPTION OF EMBODIMENTS

The exemplary embodiments of the present disclosure will be described in more detail below with reference to the accompanying drawings. Although the exemplary embodiments of the present disclosure are shown in the drawings, it should be understood that the present disclosure may be implemented in various forms and should not be limited by the embodiments set forth herein. On the contrary, these embodiments are provided for a more thorough understanding of the present disclosure, and to fully convey the scope of the present disclosure to those skilled in the art.

Based on the current research status, to solve the technical challenges faced in the fabrication of ultrathin high-speed single-crystal diamond probe cantilevers in related technologies, the embodiments of the present disclosure provide a method for fabricating a single-crystal diamond probe cantilever for a high-speed atomic force microscope.

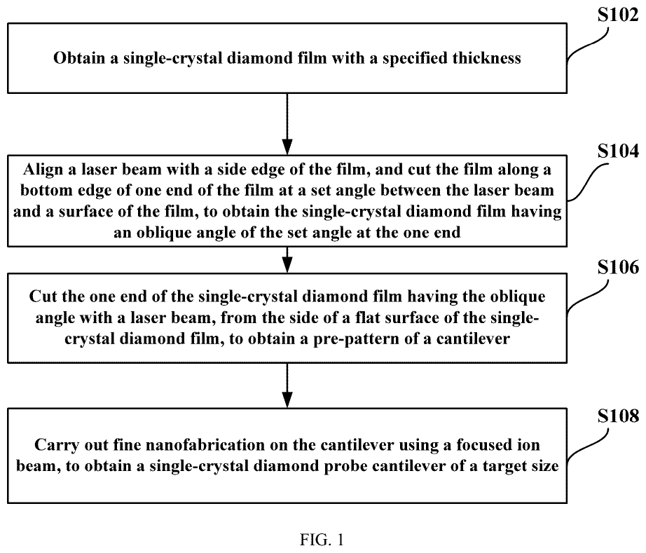

FIG. 1 shows a schematic flowchart of a method for fabricating a single-crystal diamond probe cantilever for a high-speed atomic force microscope according to an embodiment of the present disclosure. Referring to FIG. 1, the method at least includes the following steps S102 to S108.
S102: A single-crystal diamond film with a specified thickness is obtained.
S104: A laser beam is aligned with a side edge of the film, and the film is cut along a bottom edge of one end of the film at a set angle between the laser beam and a surface of the film, to obtain the single-crystal diamond film having an oblique angle of the set angle at the one end.
S106: The one end of the single-crystal diamond film having the oblique angle is cut with a laser beam, from the side of a flat surface of the single-crystal diamond film, to obtain a pre-pattern of a cantilever.
S108: Fine nanofabrication is carried out on the cantilever using a focused ion beam, to obtain a single-crystal diamond probe cantilever of a target size.

According to the method for fabricating a single-crystal diamond probe cantilever for a high-speed atomic force microscope provided by the present embodiment, firstly, a single-crystal diamond film with a specified thickness is cut at an angle using a laser beam to obtain a single-crystal diamond film having an oblique angle at one end; then, a pre-pattern of a cantilever is formed by cutting from the end where the oblique angle is located with a laser beam; and then fine nanofabrication is carried out on the cantilever using a focused ion beam technique, to finally obtain an ultrathin single-crystal diamond cantilever of a required size, thereby achieving manufacturing of an ultrathin integrated single-crystal diamond cantilever.

In some optional embodiments of the present disclosure, the specified thickness of the single-crystal diamond film may be in a range of 30-70 μm, for example, 40 μm, 45 μm, 50 μm, 55 μm, 60 μm, and 65 μm. A single-crystal diamond film of an appropriate thickness is selected as a base film for subsequent machining, to ensure that the film is not easily broken while facilitating subsequent thinning.

A length and a width of the single-crystal diamond film may be selected according to actual needs. In some embodiments, the length and the width of the single-crystal diamond film are in a range of 1-10 mm, for example, 1.5 mm, 3 mm, and 5 mm.

To ensure the quality of the finally fabricated probe cantilever as much as possible, a double-side finely polished single-crystal diamond film with clean surfaces is preferably used. Optionally, a surface roughness Ra of the single-crystal diamond film is less than 1 nm, for example, Ra is 0.8 nm.

In some optional embodiments of the present disclosure, the set angle in S104 may be set in a range of 5-20°, for example, 5°, 8°, 10°, 12°, 15°, 18°, and 20°.

The inventors discovered and confirmed through extensive experiments that setting the angle for cutting with a laser beam in the range of 5-20° is particularly advantageous for pre-patterning and thinning an ultrathin all-diamond cantilever.

Those skilled in the art should recognize that the oblique angle formed by cutting the single-crystal diamond film at an angle may also be referred to as a grazing angle.

In S106, cutting is carried out from the side of a flat surface of the single-crystal diamond film with a laser. Those skilled in the art should understand that the side of the flat surface is opposite to the other side where an oblique edge of the oblique angle is.

In some embodiments, the single-crystal diamond film may be horizontally fixed in S106, with the flat surface (i.e., the uncut polished surface) of the single-crystal diamond film facing upwards. Then by carrying out laser cutting from top to bottom, the pre-pattern of a cantilever is cut out in a direction from the vertex of the oblique angle to the interior of the single-crystal diamond film. The design of the pre-pattern is determined by the size of the cantilever.

After the nanofabrication with the focused ion beams in S108, a single-crystal diamond probe cantilever of the target size is obtained. In some optional embodiments of the present disclosure, a target thickness of the fabricated cantilever may be in a range of 50 -250 nm, for example, 60 nm, 80 nm, 90 nm, 100 nm, 120 nm, 140 nm, 150 nm, 160 nm, 180 nm, 200 nm, 220 nm, and 240 nm. The specific setting of the target thickness may be determined according to actual needs.

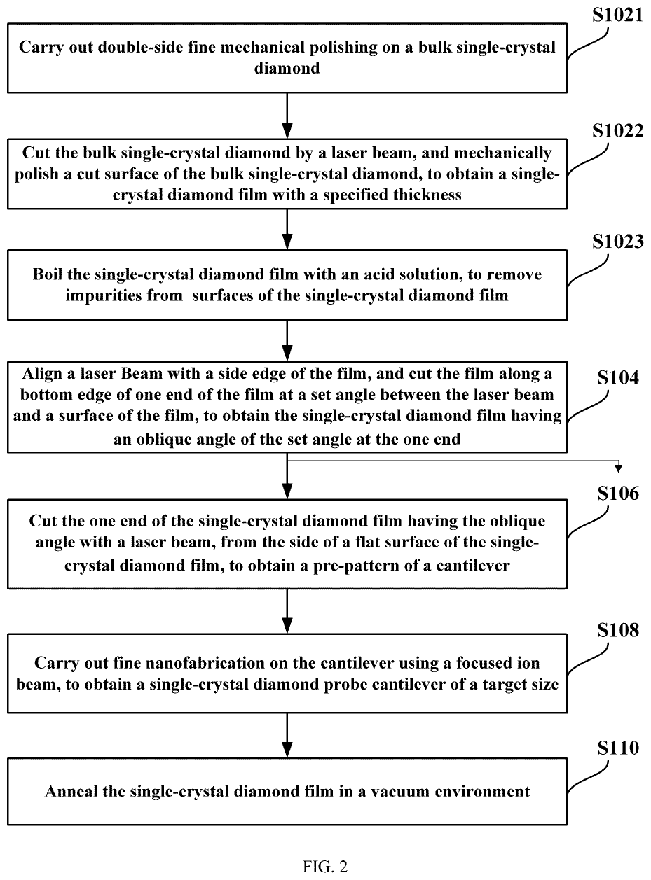

FIG. 2 shows a schematic flowchart of a method for fabricating a single-crystal diamond probe cantilever for a high-speed atomic force microscope according to another embodiment of the present disclosure.

Referring to FIG. 2, in some optional embodiments of the present disclosure, S102 may specifically include:
S1021: Double-side fine mechanical polishing is carried out on a bulk single-crystal diamond.

Optionally, the bulk single-crystal diamond may be polished to a surface roughness Ra of less than 1 nm.
S1022: The bulk single-crystal diamond is cut by a laser beam, and a cut surface of the bulk single-crystal diamond is mechanically polished, to obtain the single-crystal diamond film with the specified thickness.

In the present embodiment, the double-side polished bulk single-crystal diamond is used as a base material, and is cut and thinned by the laser cutting technique and mechanically polished to obtain the single-crystal diamond film with the specified thickness, thereby expanding the sources of single-crystal diamond films for fabrication of single-crystal diamond cantilevers.

Still referring to FIG. 2, in some optional embodiments of the present disclosure, S102 may further include:
S1023: The single-crystal diamond film is boiled with an acid solution, to remove impurities from surfaces of the single-crystal diamond film.

Specifically, the impurities, for example, may include organic pollutants, metals and the like on the surfaces of the single-crystal diamond film. A clean and double-sided polished single-crystal diamond film with the specified thickness is obtained through acid boiling and cleaning.

In some embodiments, the acid solution may be a mixture of concentrated sulfuric acid and concentrated nitric acid.

Optionally, the volume ratio of concentrated sulfuric acid to concentrated nitric acid is 3:1.

A commonly used concentrated sulfuric acid with a mass fraction of 98% may be used. A commonly used concentrated nitric acid with a mass fraction of about 65% may be used.

A boiling temperature for acid boiling may be controlled at 180-220° C.

In some optional embodiments of the present disclosure, S108 may specifically include:
the single-crystal diamond film with the pre-pattern of the cantilever is fixed to an edge of a silicon wafer in a manner that the cantilever is suspended; and
multiple fine nanofabrication is carried out on the cantilever using ion beams with sequentially decreased energy.

Specifically, the single-crystal diamond film with the pre-pattern of the cantilever may be bonded to the edge of the silicon wafer using a hot melt adhesive.

In the present embodiment, in the process of nanofabrication of the cantilever using focused ion beams, multiple fine nanofabrication is carried out on the cantilever using ion beams with sequentially decreased energy, thereby improving the fabrication quality of the single-crystal diamond cantilever.

In some further embodiments, the step of carrying out multiple fine nanofabrication on the cantilever using ion beams with sequentially decreased energy may specifically include:
first, rough machining is carried out on the cantilever using an ion beam (which may be referred to as a high-energy ion beam) of first energy; then fine machining is carried out on the cantilever using an ion beam (which may be referred to as a medium-energy ion beam) of second energy; and finally, amorphous-portion-removing machining is carried out on the cantilever using an ion beam (which may be referred to as a low-energy ion beam) of third energy to remove an amorphous portion from a surface of the cantilever, wherein the second energy is lower than the first energy but higher than the third energy.

In some specific embodiments, the first energy may be in a range of 20-30 kV, for example, 20 kV, 25 kV, and 30 kV. The second energy may be in a range of 10-20 kV, for example, 12 kV, 15 kV, and 18 kV. The third energy may be in a range of 3-5 kV, for example, 3 kV, 4 kV, and 5 kV.

Still referring to FIG. 2, in some optional embodiments of the present disclosure, following S108, the method may further include S110:
the single-crystal diamond film is annealed in a vacuum environment.

In some specific embodiments, a step of annealing the single-crystal diamond film in a vacuum environment specifically includes:
the single-crystal diamond film is sealed in high vacuum by a vacuum glass tube sealing technique, and then annealed.

In a specific embodiment, the single-crystal diamond film may be fixed in a grooved high-temperature resistant mold (e.g., a ceramic mold) after the focused ion beam machining is completed, and the mold is sealed in high vacuum by the vacuum glass tube sealing technique.

The annealing treatment may be carried out in a high-temperature annealing furnace. An annealing temperature is 900° C. or higher, and for example, the annealing temperature may be in a range of 900-2000° C., or in a range of 1000-1500° C., or in a range of 1100-1400° C., or in a range of 1200-1300° C.

It should be noted that the cutting of the bulk single-crystal diamond and/or the single-crystal diamond film with a laser beam is performed at commonly used laser parameters for single crystal diamond cutting, including laser power, laser wavelength, pulse width, pulse frequency, etc., which are well known to those skilled in the art.

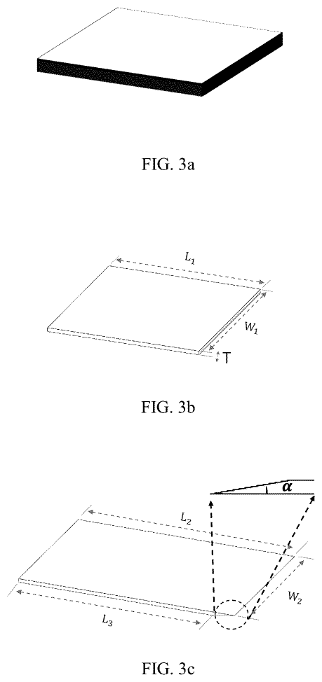

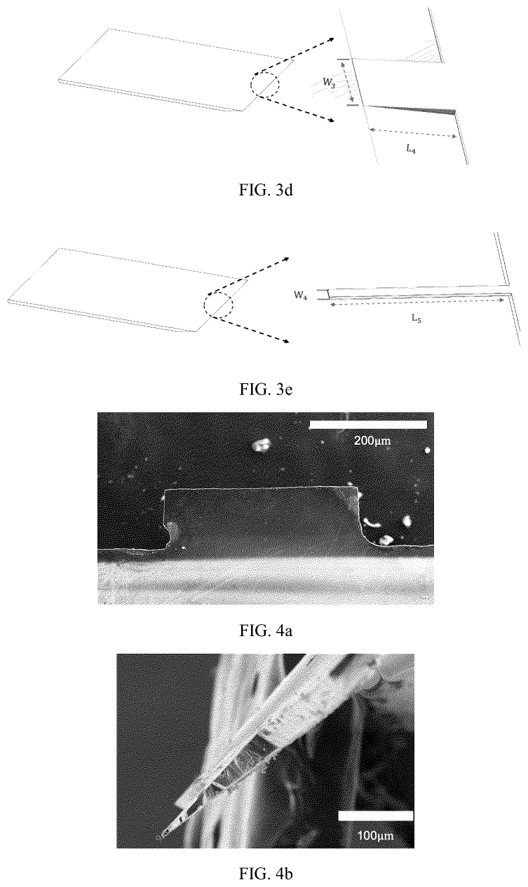

FIG. 3a to FIG. 3e show schematic diagrams of a fabrication process of a high-speed single-crystal diamond probe cantilever in a specific embodiment of the present disclosure. The method for fabricating a single-crystal diamond probe cantilever for a high-speed atomic force microscope of the present disclosure will be described in detail below through a specific embodiment with reference to FIG. 3a to FIG. 3e.

FIG. 3a and FIG. 3b show a double-side fine mechanical polishing process and a laser cutting process of the bulk single-crystal diamond. The roughness Ra of a polished diamond surfaces is required to be less than 1 nm, to obtain a double-sided polished bulk single-crystal diamond. The double-sided polished bulk single-crystal diamond is used as the base material, and is cut and thinned by the laser cutting technique, and mechanically polished to obtain a single-crystal diamond film with a thickness T=50 μm, a width W₁=3 mm, and a length L₁=3 mm. After the mechanical polishing is completed, the single-crystal diamond film is then boiled with a mixture of concentrated sulfuric acid and concentrated nitric acid (in a volume ratio of 3:1) at 200° C., until pollutants, metals and other impurities on the surface of the single-crystal diamond film are completely removed, to obtain a clean and double-side polished single-crystal diamond film with a thickness T=50 μm, a width W₁=3 mm, and a length L₁=3 mm. A mass fraction of the concentrated sulfuric acid used is 98%, and a mass fraction of the concentrated nitric acid used is 65%.

FIG. 3c shows the following process: the thinned single-crystal diamond film is mechanically fixed, a laser beam is aligned with a side edge of the film, and the film is cut at an angle of about 10° along a bottom edge of the film to obtain a single-crystal diamond film having a grazing angle α of 10° at one end. As shown in FIG. 3c, the overall single-crystal diamond film has a width W₂=3 mm, a length L₂=3 mm, and a length L₃=2.42 mm.

FIG. 3d shows the following process: the single-crystal diamond film is mechanically fixed, and cut with a laser beam from top to bottom, wherein the polished surface of the single-crystal diamond film faces upward, and then the pre-pattern of a cantilever is cut out from the end where the grazing angle is located. The design of the pre-pattern is determined by the size of the cantilever, and the pre-pattern of the cantilever on the surface of the single-crystal diamond cut at an angle has a width W₃=5 μm and a length L₄=10 μm.

FIG. 3e shows the following process: finally, the cut single-crystal diamond film is bonded to an edge of a window silicon wafer using a hot melt adhesive in a manner that a cantilever portion is suspended, and fine nanofabrication is carried out on the cantilever by the focused ion beam technique. The nanofabrication process includes three parts. Firstly, rough machining is carried out using a high-energy ion beam (30 kV) to obtain an approximate pattern of the cantilever; then, fine machining is carried out on the pattern of the cantilever using a medium-energy ion beam (15 kV), to obtain a finer pattern of the cantilever, and the thickness of the cantilever is reduced; and finally, amorphous-portion-removing machining is carried out using a low-energy ion beam (5 kV) to remove the amorphous portion from most of the surface of the diamond cantilever, to obtain an ultra-thin cantilever of a designed size, and the pattern of the cantilever has a width W₄=2 μm, a length L₅=7 μm, and a thickness of 200 nm. A smaller thickness (less than 100 nm) may be achieved by further thinning the cantilever.

FIG. 4a and FIG. 4b show a top view and a side view under an electron microscope of a single-crystal diamond film having a cutting angle of 10°, which is obtained in an embodiment of the present disclosure. FIG. 4a is the top view under an electron microscope of the single-crystal diamond film having a cutting angle of 10°, which is obtained in an embodiment of the present disclosure. The size of the single-crystal diamond film may be adjusted according to the precision of laser machining, and the overall material and the cantilever portion are all of integrated single crystal diamond. A scale of FIG. 4a is 200 μm. FIG. 4b is the side view under an electron microscope of the single-crystal diamond film having a cutting angle of 10°, which is obtained in an embodiment of the present disclosure, with a specific cutting angle of about 9.6°. A scale of FIG. 4b is 100 μm.

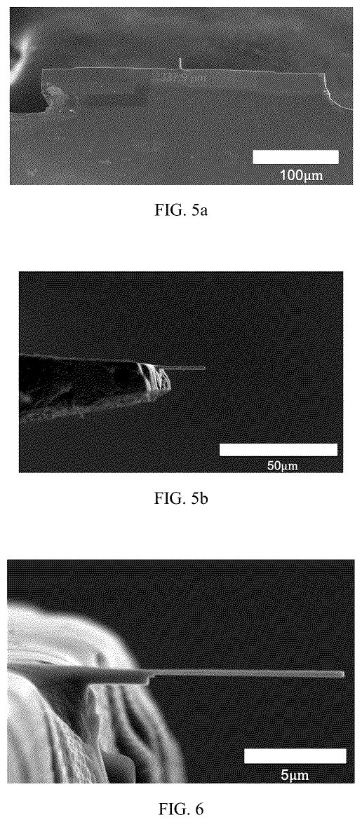

FIG. 5a and FIG. 5b show a top view and a side view under an electron microscope of a cantilever structure fabricated in an embodiment of the present disclosure prior to focused ion beam machining. FIG. 5a is the top view under an electron microscope of the cantilever structure fabricated in an embodiment of the present disclosure prior to thinning using a focused ion beam, with a scale of 100 μm. FIG. 5b is the side view under an electron microscope of the cantilever structure fabricated in an embodiment of the present disclosure prior to thinning using a focused ion beam, with a scale of 50 μm.

FIG. 6 shows a side view under an electron microscope of a cantilever structure fabricated in an embodiment of the present disclosure after focused ion beam machining, with a scale of 5 μm. It can be observed from FIG. 6 that the thickness of the cantilever is approximately 200 nm as designed. A smaller thickness (less than 100 nm) may be achieved by further thinning the cantilever.

Based on the same technical concept, the embodiments of the present disclosure further provide a single-crystal diamond probe cantilever for a high-speed atomic force microscope, which is an integrated all single-crystal diamond cantilever fabricated by any of the methods described in the aforementioned embodiments or combinations thereof.

The single-crystal diamond probe cantilever fabricated in the present disclosure may be widely used in the field of precision detection. A nanotip may be deposited on the cantilever by scanning electron microscopy and focused ion beam techniques, thereby enabling detection of defects in manufacturing high-frequency semiconductors and supporting the development of nanoscale chip processes. The single-crystal diamond probe cantilever may achieve dynamic tracking of living molecules in the field of biological science, balance nanoscale resolution and biocompatibility, and achieve high-speed dynamic scanning imaging. Also, the single-crystal diamond probe cantilever may be integrated with a quantum sensor device to meet the requirements of high-precision measurement of magnetic and force signals in extreme environments.

In the specification provided here, a large number of specific details are described. However, it should be understood that embodiments of the present disclosure may be practiced without these specific details. In some examples, well-known methods, structures, and techniques are not illustrated in detail to avoid blurring understanding of the present specification.

So far, those skilled in the art should recognize that although various exemplary embodiments of the present disclosure have been shown and described in detail herein, many other variations or modifications consistent with the principles of the present disclosure still can be directly determined or derived according to the disclosed contents of the present disclosure without departing from the spirit and scope of the present disclosure. Therefore, the scope of the present disclosure should be understood and recognized as covering all these other variations or modifications.

What is claimed is:

1. A method for fabricating a single-crystal diamond probe cantilever for a high-speed atomic force microscope, comprising:
obtaining a single-crystal diamond film with a specified thickness;
aligning a laser beam with a side edge of the film, and cutting the film along a bottom edge of one end of the film at a set angle between the laser beam and a surface of the film, to obtain the single-crystal diamond film having an oblique angle of the set angle at the one end;
cutting the one end of the single-crystal diamond film having the oblique angle with a laser beam, from the side of a flat surface of the single-crystal diamond film, to obtain a pre-pattern of a cantilever; and
carrying out fine nanofabrication on the cantilever using a focused ion beam, to obtain a single-crystal diamond probe cantilever of a target size.

2. The method for fabricating a single-crystal diamond probe cantilever for a high-speed atomic force microscope according to claim 1, wherein the set angle is in a range of 5-20°.

3. The method for fabricating a single-crystal diamond probe cantilever for a high-speed atomic force microscope according to claim 1, wherein the specified thickness is in a range of 30-70 μm; and
a target thickness of the cantilever is in a range of 50 -250 nm.

4. The method for fabricating a single-crystal diamond probe cantilever for a high-speed atomic force microscope according to claim 1, wherein a step of carrying out fine nanofabrication on the cantilever using a focused ion beam, to obtain a single-crystal diamond probe cantilever of a target size comprises:
fixing the single-crystal diamond film with the pre-pattern of the cantilever to an edge of a silicon wafer in a manner that the cantilever is suspended; and
carrying out multiple fine nanofabrication on the cantilever using ion beams with sequentially degreased energy.

5. The method for fabricating a single-crystal diamond probe cantilever for a high-speed atomic force microscope according to claim 4, wherein a step of carrying out multiple fine nanofabrication on the cantilever using ion beams with sequentially degreased energy comprises:
carrying out rough machining on the cantilever using an ion beam of first energy;
carrying out fine machining on the cantilever using an ion beam of second energy; and
carrying out amorphous-portion-removing machining on the cantilever using an ion beam of third energy to remove an amorphous portion from a surface of the cantilever, wherein the second energy is lower than the first energy but higher than the third energy.

6. The method for fabricating a single-crystal diamond probe cantilever for a high-speed atomic force microscope according to claim 5, wherein
the first energy is in a range of 20-30 kV;
the second energy is in a range of 10-20 kV; and
the third energy is in a range of 3-5 kV.

7. The method for fabricating a single-crystal diamond probe cantilever for a high-speed atomic force microscope according to claim 1, wherein a step of obtaining a single-crystal diamond film with a specified thickness comprises:
carrying out double-side fine mechanical polishing on a bulk single-crystal diamond; and
cutting the bulk single-crystal diamond by a laser beam, and mechanically polishing a cut surface of the bulk single-crystal diamond, to obtain the single-crystal diamond film with the specified thickness.

8. The method for fabricating a single-crystal diamond probe cantilever for a high-speed atomic force microscope according to claim 7, wherein the step of obtaining a single-crystal diamond film with a specified thickness further comprises:
boiling the single-crystal diamond film with an acid solution, to remove impurities from surfaces of the single-crystal diamond film,
wherein the acid solution is a mixture of concentrated sulfuric acid and concentrated nitric acid, with a volume ratio of concentrated sulfuric acid to concentrated nitric acid being 3:1; and
a boiling temperature is maintained at180-220° C..

9. The method for fabricating a single-crystal diamond probe cantilever for a high-speed atomic force microscope according to claim 1, wherein following fine nanofabrication on the cantilever using a focused ion beam, the method further comprises:
annealing the single-crystal diamond film in a vacuum environment.

10. The method for fabricating a single-crystal diamond probe cantilever for a high-speed atomic force microscope according to claim 9, wherein a step of annealing the single-crystal diamond film in a vacuum environment comprises:
fixing the single-crystal diamond film in a grooved high-temperature resistant mold;
sealing the mold in high vacuum by a vacuum glass tube sealing technique; and
annealing the single-crystal diamond film at an annealing temperature of 900° C. or higher.

11. A single-crystal diamond probe cantilever for a high-speed atomic force microscope, fabricated by the method according to claim 1.
